(19) United States
(12) Patent Application Publication
(10) Pub. No.: US 2020/0178726 A1
(43) Pub. Date: Jun. 11, 2020

(54) SOLAR POWERED COLD CUP

(71) Applicant: Jerry Wilbourn, Huntsville, AL (US)

(72) Inventor: Jerry Wilbourn, Huntsville, AL (US)

(21) Appl. No.: 16/211,237

(22) Filed: Dec. 6, 2018

(51) Int. Cl. A47J 36/24; A47J 41/00; B65D 81/38; A47G 19/22

(52) U.S. Cl. CPC A47J 36/2466; A47J 41/0072; H02S 99/00; B65D 81/3874; A47G 19/2288; A47J 41/0044

(57) ABSTRACT

A solar powered cooler cup is presented. The cup holds a beverage and may be transportable. The cup has a handle and a lid which allow for transport without fear of leakage or spillage. The cup also has a energy plant, a cooling segment and a heating coil. An on/off switch allows the power to be turned off when the cup is not in use. A system switch is provided that allows the switching from the cooling system to the heating system or vice versa. Further there is a charging port which may preferably be a USB port. A solar panel is coupled to the outside of the cup and provides energy for the system used to keep the beverage at a desired temperature. The solar panel may also charge the battery where the energy is stored in the plant.

### FIELD OF THE INVENTION

This invention relates to beverage containers. More particularly, it relates to beverage containers that are powered to stay cold.

### BACKGROUND

Containers that are used to hold various types of liquids are well known. Some such containers are specifically intended to be used to hold a beverage of some kind. A person can access the beverage in the container when they wish to consume the beverage.

Some such beverage containers are specifically adapted to be used by persons who wish to hold a cold beverage or a beverage that is at the same temperature as the environment in them. Such containers may be used by an athlete or other person engaged in an exercise activity. Such a beverage bottle may be used by a person during or after physical activity by the person. Often such containers are made of materials such as metals or hard plastics that can resist breakage when subjected to at least a moderate impact force.

Other containers are adapted for specific use to hold hot or cold liquids such as containers for use in holding hot beverages. One of the desirable features of the material used that is in contact with the liquid is that the container material will remain inert at elevated temperatures. Glass has been used as an inert material in constructing hot beverage containers. The holding of beverages in glass containers is considered desirable by many consumers of beverages. However, glass is brittle and particularly prone to breakage when subject to impact forces.

It is known to construct a relatively breakage-resistant container that is specifically adapted to hold a hot beverage. By way of example, in some such composite containers, a glass inner vessel is encased within a hard-outer shell. The hard-outer shell provides some level of protection for the glass inner vessel. Such containers can readily hold both hot and cold beverages within the inner glass vessel.

Due to their construction, such containers are relatively good in reducing pace of the loss of temperature of hot drinks and the pace of the increase in temperature of cold drinks, towards the temperature of the environment. However, they may still to some degree be prone to breakage, particularly when used in an environment where a person is engaged in physical activity where the risk to an impact force is increased compared to normal use.

Also, when constructing containers for holding liquids, there are other design considerations that may have to be considered. For example, providing a re-sealable container that can be used multiple times raises challenges. Also, providing containers that employ materials that are considered to be safe from a human/animal health perspective may also be important, particularly for beverage containers.

Improvements in known liquid containers are desired.

### BRIEF DESCRIPTION OF THE DRAWINGS

FIG. 1 is an illustrated interior of an exemplary cooler cup.

FIG. 2 is an illustrated interior of a different embodiment of the exemplary cooler cup.

FIG. 3 is an illustrated example of an exterior of an exemplary cooler cup.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

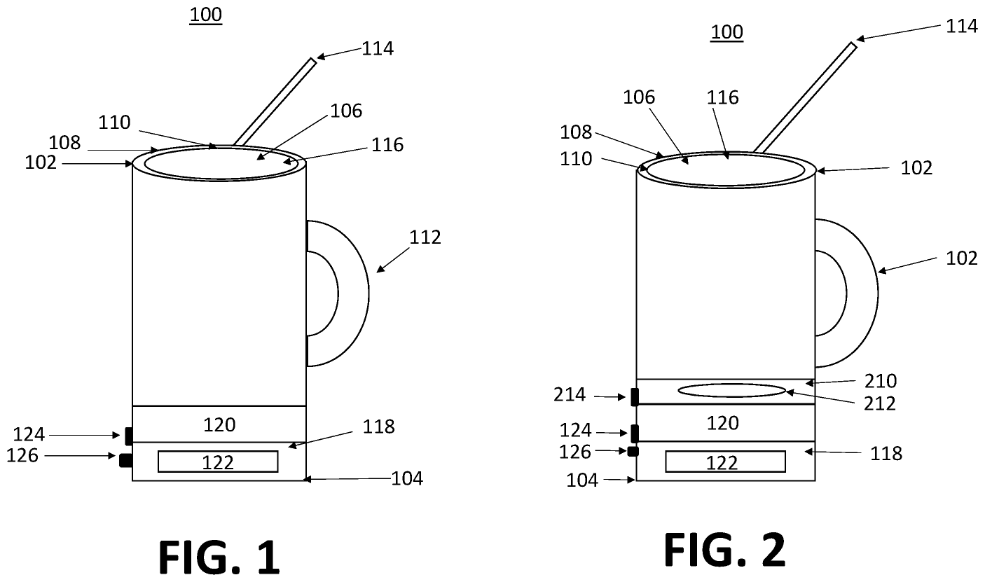

Referring to FIG. 1, a beverage cup 100 is shown. The beverage cup (apparatus) 100 is useful for containing cold or hot beverages and providing a mechanism to make the beverage portable or mobile without spillage. The exemplary beverage cup 100 is further useful for maintaining the beverage contained in the beverage cup 100 at a proper temperature and can cool or heat the beverage to maintain the desired temperature.

The beverage cup 100 has a body having a top 102, a bottom 104, and an inside 106. The beverage cup 100 may be made of material which can hold a beverage without leaking, is durable and prevents a user's hand from becoming overly cold or overly warm from the beverage contained in the beverage cup 100. The beverage cup 100 may be made of a hard, durable material such as hard plastic, metal, etc.

The inside 106 of the beverage cup 100 acts as a receptacle for holding the beverage. The beverage cup 100 is generally built to contain a predetermined maximum amount of beverage, such as sixteen (16) ounces, twelve (12) ounces, twenty-four (24) ounces, etc. Preferably the exemplary beverage cup 100 holds sixteen (16) ounces of liquid in the inside reservoir.

The beverage cup 100 has an outside wall 108 and an inside wall 110. Between the outside wall 108 and the inside wall 110 is an insulation 109 to help keep the temperature of the beverage contained in the inside 106 of the beverage cup 100 at the desired temperature.

The beverage cup 100 further has a handle 112. The handle 112 is useful in being able to pick the beverage cup 100 up to drink from or to carry the beverage cup 100 to multiple locations to enjoy the beverage contained in the beverage cup 100. The beverage cup 100 may also have a straw 114 and a lid 116. The straw 114 is placed through a hole or opening in the lid 116 which is placed on the top 102 of the beverage cup 100 and configured to seal the body of the cup. The straw 114 may be made of a material that can be formed into a cylinder with a hollow core, such as metal, plastic, etc.

The beverage cup 100 has a plurality of segments 118, 120 which are sealed from the beverage contained in the beverage cup 100 and located directly above the bottom 104 of the body of the cup 100. The segments 118, 120 may be the same size or different sizes. The segment 118 is useful to carry a battery or other power source such as a solar energy power plant, for powering any device in the beverage cup 100. The battery 122 may be a NiCad battery, a replaceable battery, a rechargeable battery, a solar panel, etc.

The segment 120 is useful for holding freon or other chemicals or devices which are used to cool the beverage contained in the beverage cup 100. The battery 122 provides the power to a device to expel the chilled air from the segment 120.

The beverage cup 100 may also have an on/off switch (power switch) 124 and a charging port 126. The on/off switch 124 is located on a lower portion of the body of the cup and is useful in turning the cooling segment 120 on and allowing the beverage to be kept at the desired temperature. The charging port 126 is located below the power switch and may be useful in recharging the battery 122 or in providing ac/dc current to the beverage cup 100 directly.

Referring to FIG. 2, another embodiment of the beverage cup 100 is shown. The beverage cup 100 is useful for containing cold or hot beverages and providing a mechanism to make the beverage portable or mobile without spillage. The exemplary beverage cup 100 is further useful for maintaining the beverage contained in the beverage cup 100 at a proper temperature and can cool or heat the beverage to maintain the desired temperature.

The beverage cup 100 has a top 102, a bottom 104, and an inside 106. The beverage cup 100 may be made of material which can hold a beverage without leaking, is durable and prevents a user's hand from becoming overly cold or overly warm from the beverage contained in the beverage cup 100. The beverage cup 100 may be made of a hard, durable material such as hard plastic, metal, etc.

The inside 106 of the beverage cup 100 acts as a receptacle for holding the beverage. The beverage cup 100 is generally built to contain a predetermined maximum amount of beverage, such as sixteen (16) ounces, twelve (12) ounces, twenty-four (24) ounces, etc. Preferably the exemplary beverage cup 100 holds sixteen (16) ounces of liquid in the inside reservoir.

The beverage cup 100 has an outside wall 108 and an inside wall 110. Between the outside wall 108 and the inside wall 110 is an insulation to help keep the temperature of the beverage contained in the inside 106 of the beverage cup 100 at the desired temperature.

The beverage cup 100 further has a handle 112. The handle 112 is useful in being able to pick the beverage cup 100 up to drink from or to carry the beverage cup 100 to other locations to enjoy the beverage contained in the beverage cup 100. The beverage cup 100 may also have a straw 114 and a lid 116. The straw 114 is placed through a hole or opening in the lid 116 which is placed on the top 102 of the beverage cup 100. The straw 114 may be made of a material that can be formed into a cylinder with a hollow core, such as metal, plastic, etc.

The beverage cup 100 has a plurality of segments 118, 120, 210 which are sealed from the beverage contained in the beverage cup 100. The segments 118, 120 may be the same size or different sizes. The segment 118 is useful to carry a battery or other power source such as a solar energy power plant, for powering any device in the beverage cup 100. The battery 122 may be a NiCad battery, a replaceable battery, a rechargeable battery, or may be a solar panel, etc.

The segment 120 is useful for holding freon or other chemicals or devices which are used to cool the beverage contained in the beverage cup 100. The battery 122 provides the power to a device to expel the chilled air from the segment 120.

The segment 210 contains heating coils 212. The heating coils 212 are energized by the battery 122 and emit heat as the heating coils 212 turn energy into heat.

The beverage cup 100 may also have an on/off switch 124 and a charging port 126. The on/off switch 124 is useful in turning the cooling segment 120 on and allowing the beverage to be kept at the desired temperature. The charging port 126 may be useful in recharging the battery 122 or in providing ac/dc current to the beverage cup 100 directly.

The beverage cup may in another embodiment have a system switch 214. The system switch 214 is useful in switching the desired segment 120, 210 to be operational. When the user has a cold beverage, the user would actuate the system switch 214 to activate the segment 120 to provide cooling to the beverage. If the user has a warm beverage, the user would actuate the system switch 214 to provide warming or heating of to the beverage contained in the beverage cup 100.

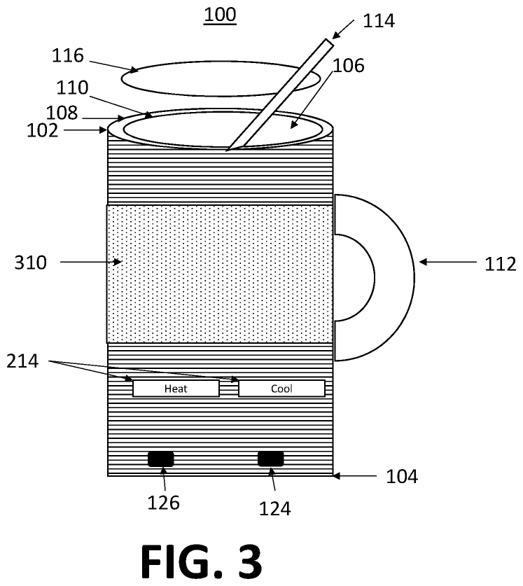

Moving now to FIG. 3, an exterior view of the exemplary beverage cup 100 is presented. The exterior view of the beverage cup 100 has a solar panel 310, a top 102, a bottom 104 and a top 102.

The solar panel 310 receives the sun's energy through sunshine and produces electricity. The solar panel 310 is communicatively coupled to the battery 122 of FIG. 1 and FIG. 2. The beverage cup 100 further has a charging port 126 and a on/off switch 124. The charging port 126 provides a communicative connection to the battery 122 as an alternative to the solar panel 310. The charging port 126 may be a USB port, such as a USB-C, etc. The on/off switch 124 may be a toggle switch, a touch button, a push button, etc.

The beverage cup 100 further has a system switch 214. The system switches 214 may be separate actuators such as shown in FIG. 3, a toggle switch, a touch panel, etc. The system switches 214 provides a mechanism to actuate a system such as the cooling system of 120 or the heating coils 212.

Between the inner wall 108 and the outer wall 110 of the beverage cup 100 is an insulator. The insulator may be foam, etc. The top 102 is open to a inside 106. The inside 106 is an open space that is allows a reservoir to hold a liquid or beverage. The size of the reservoir is predetermined, preferably sixteen ounces.

The beverage cup 100 also has a lid 116. The lid 116 is coupled to the top 102 of the beverage cup 100. The lid 116 cover over the outer wall 108 of the beverage cup 100 to avoid spillage and leakage from the reservoir.

A straw 114 is provided that couples with the lid 116. The lid 116 has a port or opening in which the straw 114 may securely couple to allowing for the user to drink the beverage without tilting or lifting the beverage cup.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An apparatus for regulating the temperature of a beverage, said apparatus comprising:
a body having a top and bottom;
an inside configured to hold a predetermined amount of said beverage;
an insulation between an outside wall and an inside wall, said insulation configured to keep a temperature of said
beverage at a desired temperature
a handle, said handle attached to said outside wall and configured to carry said apparatus to multiple locations;
a lid, said lid having an opening and configured to seal said body of said apparatus;
a straw, said straw configured to fit through said opening in said lid;
a plurality of segments, said plurality of segments located directly above said bottom of said body;
a power switch, said power switch located on a lower portion of said body and configured to turn apparatus on and
off; and
a charging port, said charging port located below said power switch and configured to charge said apparatus.

2. The apparatus of claim 1, wherein said plurality of segments is 2 segments.

3. The apparatus of claim 1, wherein said predetermined amount of said beverage is 16 ounces.

4. The apparatus of claim 1, wherein said predetermined amount of said beverage is 12 ounces.

5. The apparatus of claim 1, wherein said predetermined amount of said beverage is 24 ounces.

6. The apparatus of claim 1, wherein said plurality of segments is the same size.

7. The apparatus of claim 1, wherein said plurality of segments is of different sizes.

8. The apparatus of claim 1, wherein one of said plurality of segments is sized to hold a power source.

9. The apparatus of claim 9, wherein another of said plurality of segments is sized to hold a chemical configured to cool said beverage.

10. The apparatus of claim 10, wherein said chemical is Freon.

11. The apparatus of claim 9, wherein another of said plurality of segments is sized to hold heating coils configured to heat said beverage.
